(19) United States
(12) Patent Application Publication
(10) Pub. No.: US 2012/0091876 A1
(43) Pub. Date: Apr. 19, 2012

(54) LED LIGHT BULB AND ITS BULB SHELL, AND METHOD OF MANUFACTURING THE BULB SHELL

(76) Inventor: CHING-YUAN HSIAO, TAIPEI COUNTY (TW)

(21) Appl. No.: 12/905,129

(22) Filed: Oct. 15, 2010

(51) Int. Cl. H01J 61/52; H01J 9/24; H01K 1/30

(52) U.S. Cl. 313/46; 313/116; 445/23

(57) ABSTRACT

A portion of a bulb shell of a LED light bulb is selected to be applied with a diffusion layer thereon to increase the amount of light projecting in the lateral and backward directions of the LED light bulb and thereby expand the effective illuminating space of the LED light bulb. A bulb shell is produced by applying a refractive film or fluorescent powder to a frosted shell base, and the process is thus simple, low-cost, and compatible with the manufacturing process of ordinary bulb shells.

### FIELD OF THE INVENTION

The present invention is related generally to a LED light bulb and, more particularly, to a bulb shell of a LED light bulb and a method of manufacturing the bulb shell.

### BACKGROUND OF THE INVENTION

As shown in FIG. 1, an incandescent light bulb includes a bulb base 1 and a bulb shell 2 combined together, with a tungsten filament inside thereof. Recently, light-emitting diode (LED) devices have gradually replaced the tungsten filament as the light source of light bulbs for power reduction of the light bulbs. However, LEDs are not suitable for omni-directional lighting because a LED emits light with a high directivity, typically concentrated in a 120-degree conical space in front of the LED. Moreover, a LED device requires a power converter and a heat sink for commercial use, and these additional devices are typically disposed between the bulb base 1 and the bulb shell 2 and therefore block the lateral and backward projection of light from the LED device. While it is feasible to add a reflector in front of the LED device to increase the amount of light projecting in the lateral and backward directions, lighting uniformity will be impaired as a result, and furthermore the costs will increase greatly.

### SUMMARY OF THE INVENTION

An object of the present invention is to enhance the lateral and backward illumination of a LED light bulb and thereby expands the effective illuminating space of the LED light bulb.

According to the present invention, a bulb shell of a LED light bulb includes a frosted shell base and a diffusion layer occupying a portion of the frosted shell base for enhancing lateral and backward illumination of the LED light bulb.

According to the present invention, a method of manufacturing a bulb shell of a LED light bulb includes preparing a transparent shell base, frosting the shell base, and applying a diffusion layer onto a portion of the frosted shell base for enhancing lateral and backward illumination of the LED light bulb.

According to the present invention, a LED light bulb includes a bulb base, a container combined to the bulb base, a heat sink inside of the container, a LED device attached on the heat sink, and a bulb shell combined to the container, wherein a portion of the bulb shell is occupied by a diffusion layer for enhancing lateral and backward illumination of the LED light bulb. Preferably, the container has a plurality of vent holes, and the heat sink has a plurality of fins facing the plurality of vent holes. Preferably, the container has a threaded head threaded on the bulb base.

According to the present invention, a portion of a bulb shell of a LED light bulb is selected to be applied with a diffusion layer thereon to increase the amount of light projecting in the lateral and backward directions of the LED light bulb and thereby expand the effective illuminating space of the LED light bulb. A bulb shell according to the present invention is produced by applying a refractive film or fluorescent powder onto a frosted shell base, and the process is thus simple, low-cost, and compatible with the manufacturing process of ordinary bulb shells.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a side view of a conventional incandescent light bulb;

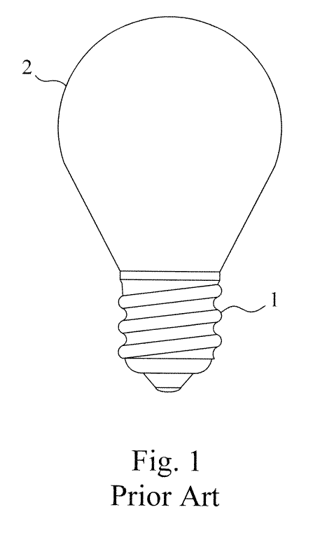

FIG. 2 is an explosive side view of a LED light bulb according to the present invention;

FIG. 3 is a diagram showing a bulb shell of a tubular shape according to the present invention;

FIG. 4 is a diagram showing a bulb shell of a semi-tubular shape according to the present invention;

FIG. 5 is a diagram showing the distribution of light projecting from a conventional LED light bulb;

FIG. 6 is a diagram showing the distribution of light projecting from a LED light bulb according to the present invention; and

FIG. 7 is the flowchart of a method of manufacturing a bulb shell of a LED light bulb according to the present invention.

### DETAILED DESCRIPTION OF THE INVENTION

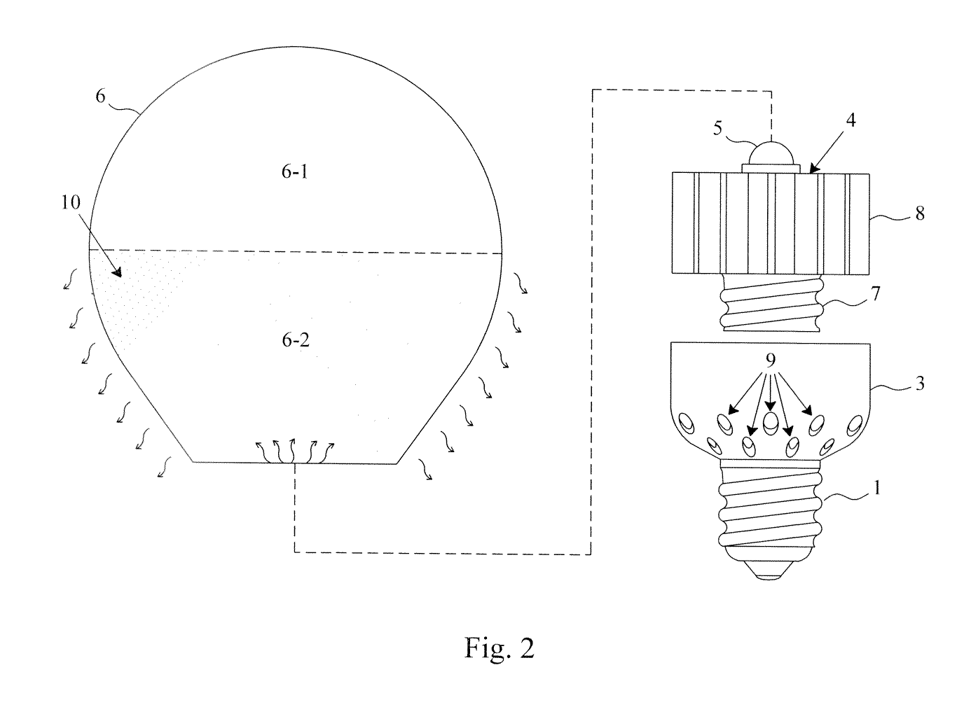

FIG. 2 shows an embodiment of the present invention, in which a LED light bulb includes a container 3 combined to a bulb base 1, a heat sink 4 disposed inside of the container 3, a LED device 5 attached on the heat sink 4, and a bulb shell 6 of a globular shape combined to the container 3. The heat sink 4 has a threaded head 7 to be threaded into the bulb base 1 and a plurality of fins 8 to assist heat dissipation. To further enhance heat dissipation, the container 3 has a plurality of vent holes 9 to face the fins 8 when the heat sink 4 is disposed inside of the container 3. Therefore, the heat generated by the LED device 5 is conducted to the heat sink 4 and dissipated by the fins 8, and then by air circulation, the dissipated heat is transferred through the vent holes 9 to the outside of the LED light bulb. The bulb shell 6, as that of an ordinary light bulb, has a frosted shell base made of glass or plastic; however, it is additionally applied with a diffusion layer 10 thereon to increase the amount of light projecting in the lateral and backward directions of the LED light bulb. The diffusion layer 10 does not necessarily occupy the entire surface of the bulb shell 6; in fact, it is sufficient to select a portion of the bulb shell 6 for the diffusion layer 10 to be applied thereon. In this embodiment, due to the diffusion layer 10, the bulb shell 6 has two regions 6-1 and 6-2 of different optical properties. The region 6-1 is similar to the bulb shell of an ordinary light bulb in that it has a frosted surface. In addition to a frosted surface, the region 6-2 has the diffusion layer 10 to further diffuse the light of the LED device 5 toward the lateral and rear spaces. Preferably, the border between the regions 6-1 and 6-2 lies where the largest outer lateral dimension of the bulb shell 6 is located, as shown in FIG. 2. Preferably, the bulb shell 6 is short and plump so as for the sidewall of the bulb shell 6 to diffuse more light toward the lateral and rear spaces.

Sometimes the light bulb having a tubular bulb shell is also called a light tube. The bulb shell of a light tube may have a shape of straight, curved or spiral cylinder or half-cylinder. The present invention is also applicable to such light bulbs and others having a bulb shell of an irregular shape.

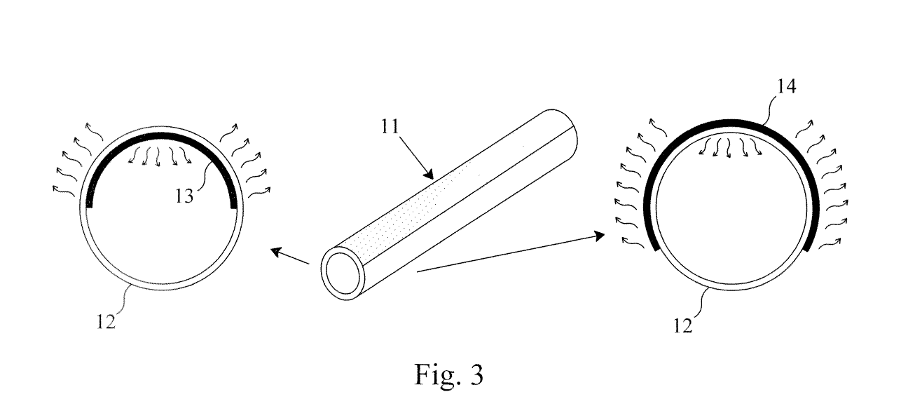

FIG. 3 shows a LED light bulb 11 having a bulb shell 12 of a tubular shape. The bulb shell 12 has a frosted shell base made of glass or plastic and a diffusion layer 13 on the inner surface thereof as shown at the left side or a diffusion layer 14 on the outer surface thereof as shown at the right side. In the embodiment at the left side, the diffusion layer 13 occupies the surface of the bulb shell 12 in a 180-degree range at the side view of the bulb shell 12. In the embodiment at the right side, the diffusion layer 14 occupies the surface of the bulb shell 12 in a 240-degree range at the side view of the bulb shell 12.

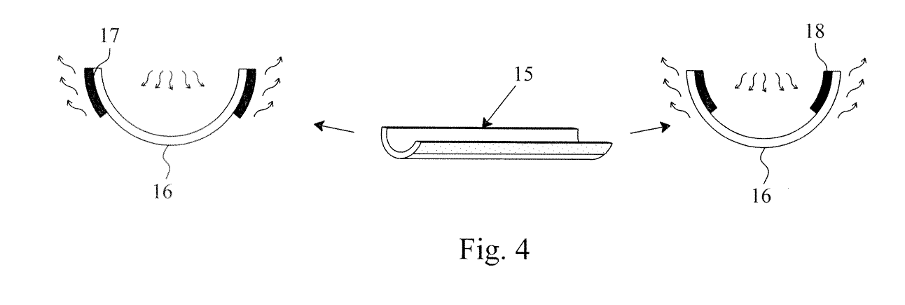

FIG. 4 shows a LED light bulb 15 having a bulb shell 16 of a semi-tubular shape whose shell base spans only 180 degrees at its side view. In the embodiment shown at the left side, the bulb shell 16 has a diffusion layer 17 on its outer surface at two lateral sides of the bulb shell 16. In the embodiment shown at the right side, the bulb shell 16 has a diffusion layer 18 on its inner surface at two lateral sides of the bulb shell 16. The diffusion layers 17 and 18 occupy the surface of the bulb shell 16 in a 60-degree range at the side view of the bulb shell 16, and each of them is split into two 30-degree parts.

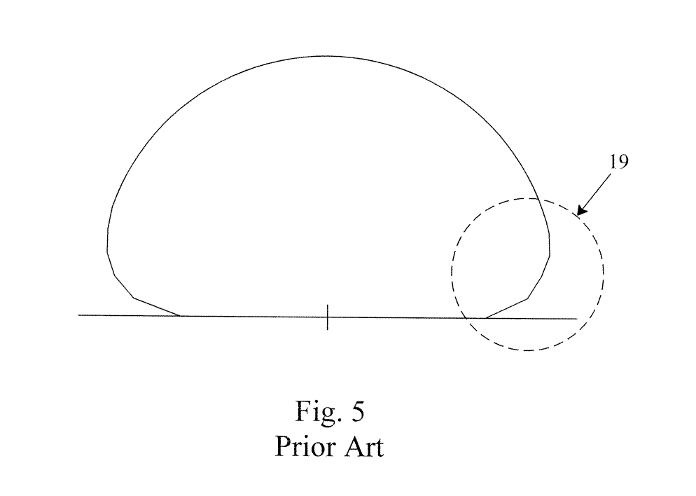

FIG. 5 is a diagram showing the distribution of light projecting from a conventional LED light bulb. Due to the light emitted by a LED concentrated in a 120-degree conical space in front of the LED, even with the assistance of a frosted bulb shell, the illumination angle of a conventional LED light bulb is at most 140 degrees or so, and the light intensity drastically decreases beyond 140 degrees. Therefore, the light distribution curve has obvious contraction at its two lateral sides, as indicated by the circle 19 shown in FIG. 5.

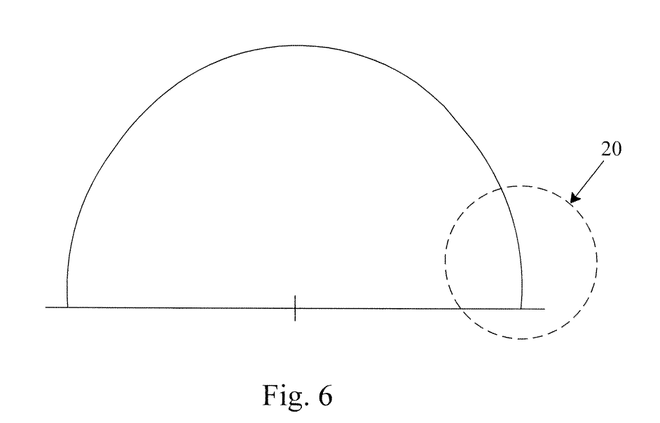

FIG. 6 is a diagram showing the distribution of light projecting from a LED light bulb according to the present invention. Due to the diffusion layer which increases the amount of light projecting in the lateral and backward directions, the light distribution curve does not bend inward at its two lateral sides, as indicated by the circle 20 shown in FIG. 6. The illuminating space is thus expanded to 180 degrees or even into the rear space beyond 180 degrees.

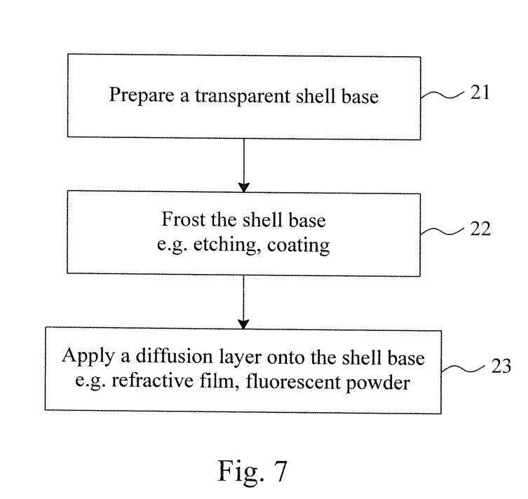

FIG. 7 is the flowchart of a method of manufacturing a bulb shell of a LED light bulb according to the present invention, in which step 21 is to prepare a transparent shell base, and step 22 is to frost the shell base, for example, by coating or etching. For the etching process, either of or both the inner and outer surfaces of the shell base is rapidly dipped into a solution, for example, mixed liquid of hydrofluoric acid, ammonium bifluoride and sulfuric acid, or mixed liquid of hydrofluoric acid, ammonium fluoride and sulfuric acid, or sulfuric acid mixed with fluorite, or hydrofluoric acid or oleum mixed with ammonium fluoride or barium sulfate, to form a rough surface on the shell base. Alternatively, it is applied a mechanical etching process, for example, sandblasting either of or both the inner and outer surfaces of the shell base. For the coating process, either of or both the inner and outer surfaces of the shell base is coated with a nano-scale material or a UV glue. Then, step 23 is to apply a diffusion layer onto either of or both the inner and outer surfaces of the shell base. For instance, a refractive film is formed on the shell base by wet painting, powder coating or electrostatic coating. The refractive film may include silica, aluminum oxidize, titania-based or polymer-based coating or film, and has a thickness ranging from 10 to 500 μm, depending on the light intensity of the LED device and the designer of the LED light bulb. Instead, the diffusion layer may include fluorescent powder, such as yttrium aluminum garnet, silicate or sulfide. In addition to the frosted surface, the diffusion layer further carries out secondary light diffusion and blurs the LED light spot.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A bulb shell of a LED light bulb, comprising:
a frosted shell base; and
a diffusion layer occupying a portion of the frosted shell base for enhancing lateral and backward illumination of the LED light bulb.

2. The bulb shell of claim 1, wherein the diffusion layer is on either of or both an inner surface and an outer surface of the frosted shell base.

3. The bulb shell of claim 1, wherein the diffusion layer has a thickness ranging from 10 to 500 μm.

4. The bulb shell of claim 1, wherein the diffusion layer comprises silica, aluminum oxidize, titania-based or polymer-based coating or film, or fluorescent powder of yttrium aluminum garnet, silicate or sulfide.

5. The bulb shell of claim 1, wherein the frosted shell base has a globular shape, tubular shape or semi-tubular shape.

6. A method of manufacturing a bulb shell of a LED light bulb, comprising the steps of:
preparing a transparent shell base;
frosting the shell base; and
applying a diffusion layer onto a portion of the frosted shell base for enhancing lateral and backward illumination of the LED light bulb.

7. A LED light bulb comprising:
a bulb base;
a container combined to the bulb base;
a heat sink inside of the container;
a LED device attached on the heat sink; and
a bulb shell combined to the container, wherein a portion of the bulb shell is occupied by a diffusion layer for enhancing lateral and backward illumination of the LED light bulb.

8. The LED light bulb of claim 7, wherein the diffusion layer is on either of or both an inner surface and an outer surface of the frosted shell base.

9. The LED light bulb of claim 7, wherein the diffusion layer has a thickness ranging from 10 to 500 μm.

10. The LED light bulb of claim 7, wherein the diffusion layer comprises silica, aluminum oxidize, titania-based or polymer-based coating or film, or fluorescent powder of yttrium aluminum garnet, silicate or sulfide.

11. The LED light bulb of claim 7, wherein the shell base has a globular shape, tubular shape or semi-tubular shape.

12. The LED light bulb of claim 7, wherein the container has a plurality of vent holes, and the heat sink has a plurality of fins facing the plurality of vent holes.

13. The LED light bulb of claim 7, wherein the container has a threaded head threaded on the bulb base.
